(19) United States
(12) Patent Application Publication
(10) Pub. No.: US 2025/0200938 A1
(43) Pub. Date: Jun. 19, 2025

(54) OBJECT ATTRIBUTE CLASSIFICATION

(71) Applicant: Axis AB, Lund (SE)

(72) Inventors: Mikael KRISTENSSON, Lund (SE); Jiandan CHEN, Lund (SE); Haiyan XIE, Lund (SE)

(73) Assignee: Axis AB, Lund (SE)

(21) Appl. No.: 18/974,827

(22) Filed: Dec. 10, 2024

(30) Foreign Application Priority Data
Dec. 18, 2023 (EP) 23217746.9

(51) Int. Cl. G06V 10/764; G06T 7/70; G06V 10/25; G06V 10/771

(52) U.S. Cl. CPC G06V 10/764; G06T 7/70; G06V 10/25; G06V 10/771; G06T 2207/20084

(57) ABSTRACT

A method for object attribute classification in an image is provided, and includes obtaining a plurality of object proposals from an artificial neural network entity trained to localize and classify objects using a plurality of feature map layers associated with different spatial resolutions; identifying a main object proposal and one or more other proposals; ranking the feature map layers from a least significant to a most significant feature map layer, and determining an attribute class for a first attribute based on attribute class confidence scores of the main and other proposals, including taking the ranking of the feature map layers as well as object location overlaps into account for the determining. A corresponding device, computer program and computer program product are also provided.

### CROSS-REFERENCE TO RELATED APPLICATION

The present application claims priority to European patent application no. 23217746.9 filed Dec. 18, 2023, the entire content of which is incorporated herein by reference.

### TECHNICAL FIELD

The present disclosure generally relates to the field of image processing. In particular, the present disclosure relates to localization and classification of objects in images as well as to classification of object attributes.

### BACKGROUND

Artificial neural network (ANN)-based architectures have proven useful for detecting instances of (semantic) objects of certain object classes in an image, such as in a still image or an image frame of a video. Examples of object classes include e.g. humans, animals, vehicles, license plates, faces, and similar. In addition to just determining whether an object of a certain object class is likely present in an image, such architectures may also be trained to estimate where in the image the object is located. One example of a contemporary such architecture is a Feature Pyramid Network (FPN), which is believed to be particularly suitable for detecting objects at different scales.

ANN-based architectures may also be used to classify one or more attributes, features, or even activities, of objects. Attributes of an object may include for example color, texture, object shape, and e.g. context, such as for example whether an object is currently facing in a certain direction, whether an object is moving or standing still, whether the object is located on a particular type of surface (such as a road, sidewalk, etc.), or any other detail of the object or its whereabouts that may be categorized and labeled. Attribute classification is considered an important task in for example computer vision, as e.g. proper classification of attributes may help to for example distinguish between different objects present in a same scene.

Contemporary ANN-based architectures are however often not capable of distinguishing between different objects, and instead work by providing a number of object proposals. Each such proposal may for example include a proposed object location, confidence scores for one or more object classes, as well as confidence scores for one or more attribute classes for one or more attributes. Post-processing of the output from the ANN-based architecture is thus required in order to establish e.g. how many distinct objects there are in an image, where the objects are located, as well as the most likely object and/or attribute classes for the object. Known such post-processing operations include the use of so-called non-maximum suppression (NMS) and intersection-over-union (IOU) measures.

The present disclosure seeks to develop such post-processing of object proposals from ANN-based architectures, and to mitigate one or more shortcomings of contemporary technology.

### SUMMARY

For the above-stated purpose, the present disclosure proposes an improved method, device, computer program and computer program product for object attribute classification in an image as defined by the accompanying independent claims. Various embodiments are defined by the accompanying dependent claims.

According to a first aspect of the present disclosure, there is provided a method of object attribute classification in an image. The method includes obtaining, from an output of an artificial neural network (ANN) entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers. The method further includes identifying, among the plurality of object proposals and based on their respective indicated object class confidence scores, a first set including a main object proposal and one or more other object proposals. The method further includes ranking the feature map layers from a least significant feature map layer to a most significant feature map layer. The method further includes determining an attribute class for the first attribute based on the one or more attribute class confidence scores of all members of the first set, including taking the ranking of the feature map layers associated with the one or more other object proposals, as well as object location overlaps of the main object proposal with the one or more other object proposals, into account as part of such determining.

As will be described in more detail later herein, the envisaged method improves upon currently available technology in that it does not just disregard information pertinent to the object attributes found in the one or more object proposals that are not considered to be the main object proposal. Instead, the envisaged method uses this information together with the information provided by the main object proposal, and especially also considers whether information originating from a particular feature map layer is to be given more or less weight when deciding upon a final estimated attribute class for the particular first attribute of the object. As will be exemplified later herein, this reduces the risk of wrongly classifying attributes when e.g. more than one object is present in a same part of the image.

In one or more embodiments of the method, the object location of each object proposal may be indicated as a bounding box, and the method may further include using an intersection-over-union (IOU) measure/operation to determine the object location overlaps of the main object proposal with the one or more other object proposals. Such measures are commonly known and readily available, and may be efficiently implemented on modern hardware.

In one or more embodiments of the method, taking the ranking and object location overlaps into account may include that an attribute class confidence score indicated by an object proposal having a larger overlap with the main object proposal and associated with a feature map layer ranked as more significant is made more significant to determining the attribute class of the first attribute than an attribute class confidence score indicated by an object proposal having a smaller object overlap with the main object proposal and associated with a feature map layer ranked as less significant. Phrased differently, the envisaged method may include that in order for information of a particular object proposal to be considered as more relevant to the determining of the attribute class for the first attribute, this object proposal should have sufficiently large overlap (in terms of estimated object location) with the main object proposal, and also originate from a feature map layer that is ranked as being more relevant for (i.e. better at) determining the first attribute of the object. This compared to e.g. some other object proposal that has a smaller overlap with the main object proposal, and which originates from a feature map layer ranked as being less relevant for (i.e. worser at) determining the first attribute of the object. For example, if a particular feature map layer is considered to be better at (i.e. operates at a resolution more suitable for) determining e.g. a color of an object, information from object proposals originating from this particular feature map layer are given more weight in the determination of the attribute class for the first attribute as long as these object proposals also propose locations which are sufficiently similar to those proposed by the main object proposal.

In one or more embodiments of the method, determining the attribute class for the first attribute may further include: for each particular attribute class of the one or more attribute classes, iterating over members of the first set that indicates an attribute class confidence score for the particular attribute class. For each iteration, determining a term equal or proportional to a product of an object location overlap size of the member of the first set with the main object proposal, an overall ranking score for the feature map layer associated with the member, and the attribute class confidence score for the particular attribute class indicated by the member, and determining an overall attribute class score for the particular attribute class as equal or proportional to a sum of the terms determined during the iterating. The method may further include determining the attribute class for the first attribute as the attribute class having the highest such overall attribute class score. Such a procedure may help to implement the above-mentioned concept of assigning more significance to object proposals that closely overlap with the main object proposal (in terms of object location) and also originates from a feature map layer that is considered better and more relevant for classifying the first attribute.

In one or more embodiments of the method, the iterating may be performed only over members of the first set that indicates a highest attribute class confidence score for the particular attribute class. Phrased differently, it is envisaged to iterate only over the members of the first set for which the particular attribute class has the top-1 attribute class confidence score. In other examples, it may instead be iterated over all members of the first set, independently of whether the particular attribute class has the top-1 attribute class confidence score or not.

In one or more embodiments of the method, the overall attribute class score for each particular attribute class may further be defined as inversely proportional to a number of the members of the first set that are iterated over. For example, it iterating over a total number P of members, the overall attribute class score may be scaled by a factor 1/P, or similar.

In one or more embodiments of the method, the overall ranking score for the feature map layer associated with the member may be defined as a ratio of a ranking score for the feature map layer to a sum of such ranking scores for all of the plurality of feature map layers. For example, if each l:th feature map layer is assigned a ranking score wₗ, the overall ranking score for the l:th feature map layer may be defined as wₗ/(Σₗ′wₗ).

In one or more embodiments of the method, the ranking of the plurality of feature map layers may depend on the first attribute. Phrased differently, the ranking of the feature map layers may be different for different attributes, which helps to take into account that different feature map layers may be more or less relevant (i.e. better or worser) for the classification of a particular type of attribute.

In one or more embodiments of the method, the method may further include identifying the main object proposal and the one or more other object proposals using a non-maximum suppression (NMS) operation.

In one or more embodiments of the method, the ANN entity may include a feature pyramid network (FPN) for providing the plurality of feature map layers. As mentioned before, FPNs may be particularly useful for detecting objects at different (spatial) scales, such as e.g. both larger and smaller objects in a same image.

In one or more embodiments of the method, the ANN entity comprises a plurality of convolutional layers for providing the different spatial resolutions.

In one or more embodiments of the method, the method is performed in/by a monitoring camera.

According to a second aspect of the present disclosure, there is provided a device for object attribute classification in an image. The device includes processing circuitry (such as a processor) that is configured to (as a result of e.g. executing instructions store in a memory of the device) cause the device to: obtain, from an output of an artificial neural network (ANN) entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers; identify, among the plurality of object proposals and based on their respective indicated object class confidence scores, a first set including a main object proposal and one or more other object proposals; obtain a ranking of the feature map layers from a least significant feature map layer to a most significant feature map layer; and determine an attribute class for the first attribute based on the one or more attribute class confidence scores of all members of the first set, including to take the ranking of the feature map layers associated with the one or more other object proposals, as well as object location overlaps of the main object proposal with the one or more other object proposals, into account as part of such determining. The device is thus configured to perform the method of the first aspect.

In one or more embodiments of the device, the processing circuitry is further configured to cause the device to perform any embodiment of the method as described herein.

In one or more embodiments of the device, the processing circuitry may be further configured to cause the device to implement the ANN entity.

In one or more embodiments of the device, the device is a monitoring camera.

According to a third aspect of the present disclosure, there is provided a computer program for object attribute classification in an image. The computer program is configured to, when executed by processing circuitry of a device (such as the device of the second aspect), cause the device to obtain, from an output of an artificial neural network (ANN) entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers; identify, among the plurality of object proposals and based on their respective indicated object class confidence scores, a first set including a main object proposal and one or more other object proposals; obtain a ranking of the feature map layers from a least significant feature map layer to a most significant feature map layer; and determine an attribute class for the first attribute based on the one or more attribute class confidence scores of all members of the first set, including to take the ranking of the feature map layers associated with the one or more other object proposals, as well as object location overlaps of the main object proposal with the one or more other object proposals, into account as part of such determining. The computer program is thus configured to cause the device to perform the method of the first aspect.

In one or more embodiments of the computer program, the computer program may be further configured to, when executed by the processing circuitry of the device, cause the device to perform any embodiment of the method of the first aspect as described herein.

According to a fourth aspect of the present disclosure, there is provided a computer program product. The computer program product includes a computer-readable storage medium storing a computer program (e.g. computer program code) according to the third aspect (or any embodiments thereof). As used herein, the computer-readable storage medium may e.g. be non-transitory, and be provided as e.g. a hard disk drive (HDD), solid state drive (SSD), USB flash drive, SD card, CD/DVD, and/or as any other storage medium capable of non-transitory storage of data. In other embodiments, the computer-readable storage medium may be transitory and e.g. correspond to a signal (electrical, optical, mechanical, or similar) present on e.g. a communication link, wire, or similar means of signal transferring, in which case the computer-readable storage medium is of course more of a data carrier than a data storing entity.

Other objects and advantages of the present disclosure will be apparent from the following detailed description, the drawings and the claims. Within the scope of the present disclosure, it is envisaged that all features and advantages described with reference to e.g. the method of the first aspect are relevant for, apply to, and may be used in combination with also the device of the second aspect, the computer program of the third aspect, and the computer program product of the fourth aspect, and vice versa.

### BRIEF DESCRIPTION OF THE DRAWINGS

Exemplifying embodiments will be described below with reference to the accompanying drawings, on which:

FIG. 1 schematically illustrates an exemplary image of a scene, wherein the scene includes two objects that are closely located and of different colors;

FIGS. 2A and 2B schematically illustrates various exemplary ANN architectures (or entities) according to embodiments of the present disclosure;

FIG. 3A schematically illustrates exemplary data indicative of object proposals output by ANN architectures according to embodiments of the present disclosure;

FIG. 3B schematically illustrates a visual representation of object locations as proposed by the data of FIG. 3A;

FIG. 3C schematically illustrates an erroneous object attribute classification resulting from application of conventional post-processing methods to the data of FIG. 3A;

FIG. 3D schematically illustrates an improved object attribute classification based on the data of FIG. 3A according to embodiments of the present disclosure;

FIG. 4 schematically illustrates a flowchart of an exemplary method of object attribute classification according to embodiments of the present disclosure;

FIGS. 5A and 5B schematically illustrates exemplary devices for object attribute classification according to embodiments of the present disclosure, and

FIG. 6 schematically illustrates an exemplary computer program, computer program product and computer-readable storage medium according to the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested. As illustrated in the Figures, the (absolute or relative) sizes of elements and regions may be exaggerated or understated vis-à-vis their true values for illustrative purposes and, thus, are provided to illustrate the general structures of the embodiments.

### DETAILED DESCRIPTION

In the present disclosure, analysis/processing of an image of a scene includes at least three operations, namely i) object locating, ii) object classification, and iii) classification of one or more object attributes.

Object locating includes to estimate where in an image of a scene the object is located. As one example, locating an object in an image may include outputting coordinates defining a box enclosing the object (a so-called “bounding box”), or any other way of identifying which pixels of the image that are considered to belong to the particular object. A same set of pixels may of course “belong” to multiple objects, e.g. if there are one or more objects at least partially hidden behind one or more other objects, and similar. A bounding box may for example be represented by coordinates of two of its opposite corners (such as e.g. x₁, y₂ for one corner, and x₂, y₂ for an opposite corner), or e.g. as a single coordinate (such as x, y) plus a width (e.g. w) and height (e.g. h) of the box (wherein the single coordinate is e.g. a center-coordinate of the box, or a coordinate of a corner of the box), or similar. The coordinates may be image coordinates. In other examples, a bounding box may instead be represented by offsets from a predefined box, and e.g. include scaling factors in case the identified bounding box is larger or smaller than the predefined box, and similar (such as when relying on so-called anchor boxes). Other ways of representing an estimated location of an object are of course also possible. Parameters such as coordinates and/or dimensions (such as height and width) may in some examples also be accompanied by respective uncertainty estimations in the coordinates and/or dimensions, and similar.

Object classification includes to estimate to what object class an object most likely belongs. Examples of object classes may include e.g. “human”, “dog”, “cat”, “car”, “motorcycle”, etc. There may also be more general classes such as “living being”, “animal”, “vehicle”, and so on. Exactly which object classes that are used depends on e.g. what type of scene one wants to analyze, and an ANN architecture may be trained accordingly to work with a particular set of object classes. Object classification may for example result in there being provided a set of confidence scores, where each confidence score is for a particular object class and indicates a certainty of the object belonging to that particular object class. A confidence score may for example be a decimal number between 0.0 and 1.0, wherein 0.0 means that the object is most likely not a member of that object class, where 1.0 means that the object is most likely a member of that object class, and where e.g. 0.5 means that it is uncertain whether the object belongs to that object class or not. Instead of decimal numbers, other representations are of course also possible, such as e.g. integer numbers corresponding to percentages 0-100% (where 0.0 is “0%” and 1.0 is “100%), or similar. Consequently, as envisaged herein, object classification is not binary, and may instead result in a number of confidence scores for a number of (predefined) object classes.

Attributes may include things like “color”, “shape”, “size”, “orientation”, etc., of an object, and a plurality of attribute classes may be provided for each such attribute. For example, a set of possible color attribute classes “red”, “green”, “blue”, etc., may be assumed for the attribute “color”; a set of possible shape attribute classes “square”, “round”, “triangular”, etc., may be assumed for the attribute “shape”, and so on. Attribute classification (for a particular attribute) thus includes estimating to which associated attribute class the particular attribute belongs. Just as for object classification, the result of such attribute classification may include one or more confidence scores indicating a certainty of the particular attribute belonging to a particular attribute class for that particular attribute.

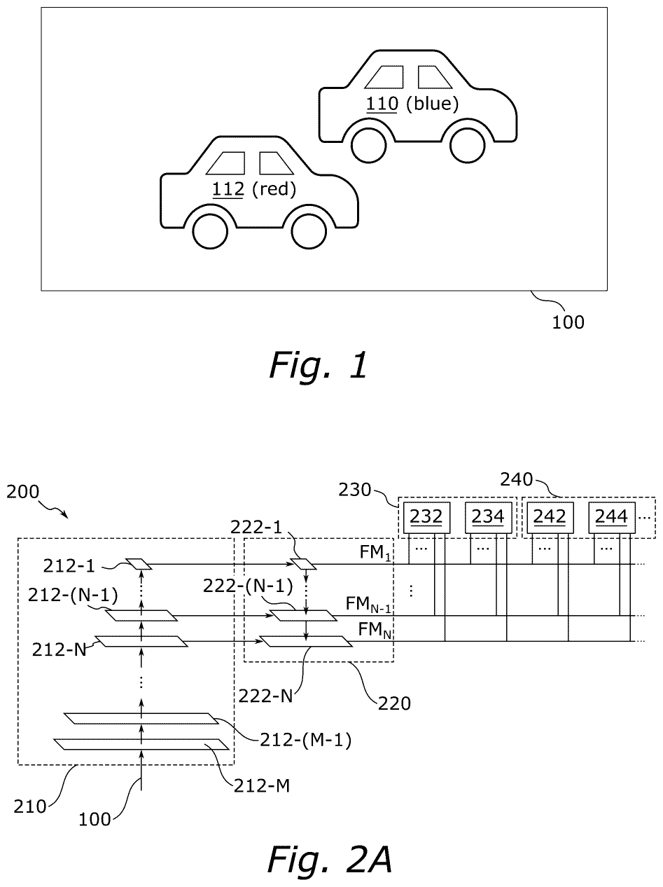

FIG. 1 schematically illustrates an exemplary image 100 of a scene, which will repeatedly be used herein to illustrate the concept underlying the present disclosure. The scene captured in the image 100 includes two particular objects, in form of a first car 110 and a second car 112. The first car 110 is blue, and the second car 112 is red. The locations of the two objects 110 and 112 are as indicated in FIG. 1. A correctly performed analysis/processing of the image 100 should therefore result in each object 110 and 112 being correctly located, correctly classified in terms of object class (i.e. with highest confidence scores for e.g. object class “car”), and also correctly classified in terms of color attribute (i.e. with highest confidence scores for e.g. color attribute classes “blue” and “red”, respectively), if assuming that the color attribute is the only important attribute in this example.

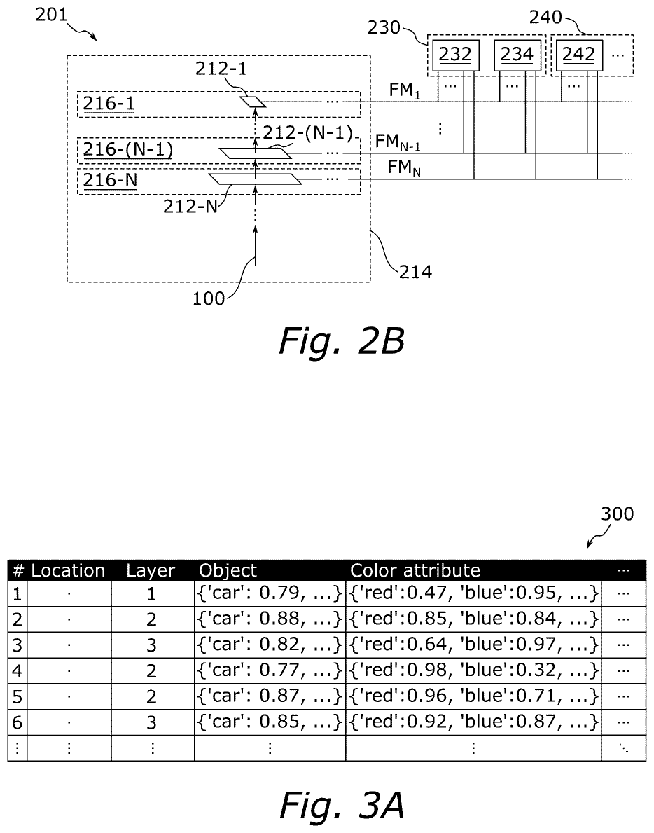

An example architecture for how to perform object locating, object classification as well as attribute classification will now be described in more detail with reference also to FIGS. 2A and 2B.

FIG. 2A schematically illustrates an exemplary artificial neural network (ANN) architecture (or entity) 200 as envisaged herein. The architecture 200 includes a bottom-up pathway 210 as well as a top-down pathway 220. The bottom-up pathway 210 includes a plurality of convolutional stages 212-1 to 212-M each serving to further reduce the spatial resolution of the input image 100 (provided to the bottom-most stage 212-M, where M is an integer indicating a total number of stages in the bottom-up pathway 210). Each stage 212-1 to 212-M may include a single ANN layer or a set of interconnected ANN layers). The bottom-most convolutional stage 212-M may for example reduce the spatial resolution of the input image 100 by one half, by e.g. using a stride of two. The output of the stage 212-M is provided as input to the next convolutional stage 212-(M−1), which may further reduce the spatial resolution (by e.g. also one half, by e.g. using a stride of two), and so on. Consequently, spatial resolution decreases when moving upwards in the bottom-up pathway 210, while the semantic information provided at each stage instead increases. The bottom-up pathway, or at least the upper part of the bottom-up pathway, is responsible for (i.e. trained for) performing feature extraction at various levels for different scales of object, and results in a plurality of feature maps at different resolutions. The bottom-up pathway 210 may e.g. be a Residual Neural Network (i.e. ResNet, as described in more detail in Kaiming He et al., Deep Residual Learning for Image Recognition, https://doi.org/10.48550/arXiv.1512.03385), a Self-Regulated Network (i.e. RegNet, as described in more detail in Jing Xu et al., RegNet: Self-Regulated Network for Image Classification, https://doi.org/10.48550/arXiv.2101.00590), or any other suitable network architecture for providing feature maps based on different scales/resolutions. The bottom-up pathway 210 and its various stages 212-1 to 212-M may e.g. be referred to as a “backbone” of the architecture 200.

The top-down pathway 220 includes a plurality of stages 222-1 to 222-N (where N is an integer indicating a total number of such stages, and wherein each stage may include one or more interconnected ANN layers). Each such stage 222-j receives as input the feature map of an associated stage 212-j of the bottom-up pathway 210, and in addition also receives (except for the top-most stage 222-1) as input the output from a higher stage in the top-down pathway 210. The top-down pathway 220 and its stages 222-1 to 222-N may e.g. be referred to as a “neck” of the architecture 200, and may for example provide various up-sampling and concatenation mechanisms to fusion different stage feature maps. Phrased differently, the backbone 210 performs initial feature extraction from the input image 100 at different scales, while the neck 220 merges those features into more sophisticated feature maps FM, e.g. by performing multi-resolution aggregation of features extracted by the backbone 210. The number M of stages is usually smaller than N, as providing also the outputs from the higher-resolution stages 212-(N+1) to 212-M of the bottom-up pathway 210 directly to the top-down pathway 220 may often be considered as too computationally expensive. The top-down pathway 220 may for example be implemented in accordance with a so-called Feature Pyramid Network (FPN, as described in more detail in Tsung-Yi Lin et al., Feature Pyramid Networks for Object Detection, https://doi.org/10.48550/arXiv.1612.03144), or an extended variant of FPN (e.g. BiFPN, as described in more detail in Mingxing Tan et al., EfficientDet: Scalable and Efficient Object Detection, https://doi.org/10.48550/arXiv.1911.09070).

The feature maps FMⱼ are then provided as input to a plurality of “head” modules of the architecture 200, including a group 230 of head modules responsible for object classification and localization, and a group 240 of one or more head modules responsible for object attribute classification. The group 230 includes e.g. an object classification module 232 configured to, based on the feature maps FMⱼ, determine whether there is an object in the image 100, and if yes also attempt to determine to which object class the object belongs. The module 232 may provide a plurality of such classifications originating from different ones of the plurality of feature maps FMⱼ. For example, the module 232 may be configured to provide one or more confidence scores for the object belonging to one or more object classes based on a particular one of the feature maps FMⱼ, and also provide one or more other confidence scores for the object belonging to the one or more object classes based on a particular other one of the feature maps FM_{j′≠j}, and so on. Such an object classification module 232 may for example be or be based on a Single Shot Detector (SSD, as described in more detail in Wei Liu et al., SSD: Single Shot MultiBox Detector, https://doi.org/10.48550/arXiv.1512.02325) using convolutional predictors for detection, or e.g. on Retinanet (as described in more detail in Tsung-Yi Lin et al., Focal Loss for Dense Object Detection, https://doi.org/10.48550/arXiv.1708.02002). The group 230 may further include an object localization module 234, configured to localize where in the image 100 an object is, and provide the result e.g. in form of a bounding box as described earlier herein. Such an object localization module 234 may e.g. provide one bounding box based on a particular one of the feature maps FMⱼ, and another bounding box based on a particular other one of the feature maps FM_{j′≠j}, and so on. Such an object localization module 234 may for example also be based on any of the two example sources provided above for the object classification module 232, but with focus on e.g. prediction of offsets from anchor boxes instead of on object class prediction, or similar.

The group 240 may e.g. include a first attribute classification module 242 configured to determine to which attribute class a particular first attribute belongs, such as e.g. for the attribute “color” as described earlier herein. The group 240 may optionally also include one or more additional attribute classification modules, such as e.g. a second attribute classification module 244 configured to classify a particular other attribute, and so on. For example, the second attribute classification module 244 may be configured to classify a texture attribute, a shape attribute, a size attribute, an attribute regarding whether an object is on a road or not, some other context attribute, etc., and the present disclosure is not limited to any particular set of attributes and/or corresponding attribute classes. Just as for the modules 232 and 234, the attribute classification modules 242 and 244 in the group 240 may be configured to e.g. output one set of confidence scores for one or more attribute classes based on a particular one of the feature maps FMⱼ, and to e.g. output another set of confidence scores for the one or more attribute classes based on a particular other one of the feature maps FM_{j′≠j}, and so on. Such attribute classification modules (e.g. 242, 244, etc.) may for example be based on same example technologies as described above for the group 230. Another example of how to implement an attribute classification module is described in Dong Liu et al., Simultaneous object localization and attribute classification using multitask deep neural networks, U.S. Pat. No. 11,087,130B2.

As a result of the output from the modules of the groups 230 and 240, the architecture 200 may be configured to provide data indicative of a plurality of object proposals, wherein each object proposal includes an estimated object location (from the module 234), one or more object class confidence scores (from the module 232) for the object belonging to one or more object classes, and one or more attribute class confidence scores (from the module 242 and/or 244) for one or more attribute classes for a particular attribute, wherein in particular each such object proposal is based on a particular one of the feature maps FMⱼ.

FIG. 2B schematically illustrates another exemplary ANN architecture (or entity) 201 as envisaged herein, which is more general than the architecture 200 described with reference to FIG. 2A. The architecture 201 highlights that it is not, within the present disclosure, important exactly how e.g. the backbone 210 and neck 220 of the architecture 200 are structured, or e.g. whether there exists both a backbone and a neck, etc., as long as there are at least a plurality of network layers 214 (or stages) (such 212-1 to 212-N) that operates (by e.g. extracting features) at different resolutions. The output from such network layers/stages 212-1 to 212-N may then e.g. be provided directly as the feature maps FMⱼ to the head modules of the groups 230 and 240, or e.g. be further processed (by using e.g. the FPN described with reference to FIG. 2A, or by any other suitable sub-architecture) before output as the feature maps FMⱼ. Thus, generally herein, it is said that each feature map FMⱼ is associated with a particular feature map layer/stage 216-j as illustrated in FIG. 2B, wherein the exact configuration/layout of each such feature map layer/stage 216-j is not important as long as the feature map layers/stages 216-j are associated with different spatial resolutions, and e.g. such that each object proposal may be referred to as being associated with a particular one of the plurality of feature map layers/stages 216-j.

As also illustrated in FIG. 2B, it is envisaged that the architecture 201 (or any architecture as envisaged herein) may include for example only a single attribute classification module (such as 242).

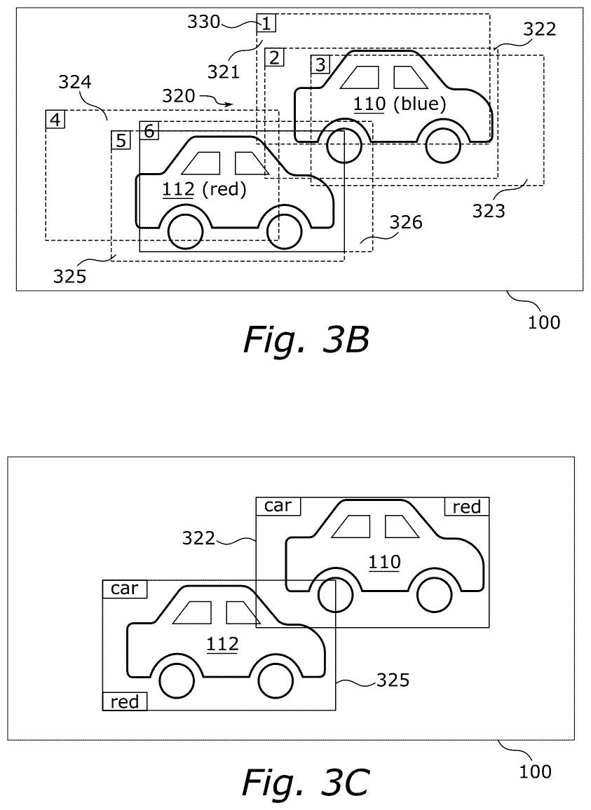

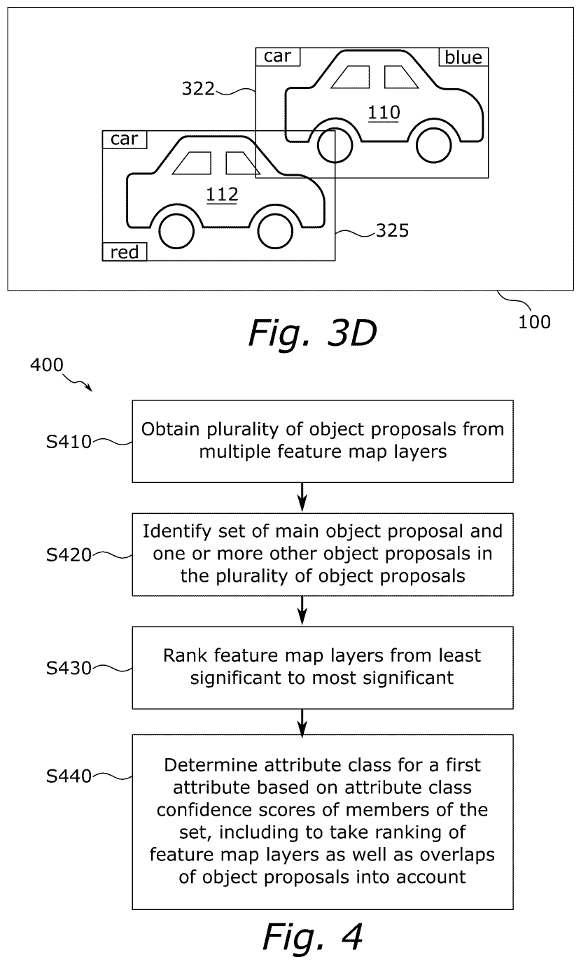

An example outcome of analyzing the image 100 of the scene using the architecture 200 or 201, as well as how the method envisaged herein may improve upon contemporary solutions of post-processing such an outcome, will now be described in more detail with reference also to FIGS. 3A, 3B, 3C and 3D.

FIG. 3A illustrates an example output from the architecture 200/201 in form of tabulated data 300. In the data 300, each row corresponds to an object proposal, and includes a proposal index (“#”, i.e. a bounding box index), an estimated object location (“Location”, in form of coordinates for two opposite corners of the box, a center coordinate plus dimensions, etc., as described earlier herein, although not explicitly shown in FIG. 3A), an identifier (“Layer”) of the feature map layer (or stage, out of layers/stages 220-1 to 220-N) from which the object proposal originates (i.e. is associated with), confidence scores for one or more object classes (“Object”, wherein the confidence score for each object class is provided as “<object class>”: <confidence score>), and confidence scores for at least a first attribute here assumed to be the color attribute (“Color attribute”, wherein the confidence score for each color attribute class is provided as “<color attribute class>”: <confidence score>). Here, the confidence scores for the object classes and color attribute classes are provide using Javascript Object Notation (JSON), but other formats are of course also possible. For the object classes, only the confidence scores for the object class “car” are shown, but there may or may not be provided such confidence scores also for one or more other object classes.

Using the first row as an example, it is seen from the data 300 that this corresponds to a first (as # equals “1”) object proposal (with a particular estimated location), that the object proposal originates from the first feature map layer (as Layer equals “1”, i.e. the first object proposal is e.g. associated with the feature map layer 216-1 shown in FIG. 2B), that it is indicated a confidence score of 0.79 for the object class “car” (as Object includes an item with key “car” and value “0.79”), and that the confidence scores for the color attribute classes are 0.48 for the attribute class “red” and 0.95 for the attribute class “blue” (as Color attribute includes an item with key “red” and value “0.47” as well as another item with key “blue” and value “0.95”). Similarly, the second row of the data 300 corresponds to a second object proposal originating from/associated with the second feature map layer (e.g. 216-2), with a confidence score of 0.88 for the object class “car”, and confidence scores for color attribute classes “red” and “blue” of 0.85 and 0.84, respectively. The third row of the data 300 corresponds to a third object proposal originating from/associated with the third feature map layer (e.g. 216-3), with a confidence score of 0.82 for the object class “car”, and confidence scores for color attribute classes “red” and “blue” of 0.64 and 0.97, respectively. The fourth row of the data 300 corresponds to a fourth object proposal originating from the second feature map layer, with a confidence score of 0.77 for the object class “car”, and confidence scores for color attribute classes “red” and “blue” of 0.98 and 0.32, respectively. The fifth row of the data 300 corresponds to a fifth object proposal originating from the second feature map layer, with a confidence score of 0.87 for the object class “car”, and confidence scores for color attribute classes “red” and “blue” of 0.96 and 0.71, respectively. The sixth row of the data 300 corresponds to a sixth object proposal originating from the third feature map layer, with a confidence score of 0.85 for the object class “car”, and confidence scores for color attribute classes “red” and “blue” of 0.92 and 0.87, respectively. The data 300 may of course include one or more additional object proposals, that are however then ignored in the current example. For this particular example, it may thus be assumed that the architecture (e.g. 201) includes three feature map layers 216-1 to 216-3, i.e. N=3.

More generally, it can, as envisaged herein, further be assumed that the architecture used to analyze the image 100 includes N feature map layers, and that there is thus a corresponding set of different feature map layers F=[F₁, F₂, . . . , F_{N}] (where e.g. Fⱼ is feature map layer 216-j in FIG. 2B). It can be assumed that there is a set of one or more different object classes O=[O₁, O₂, . . . , Oⱼ], a set of one or more different attributes A=[A₁, A₂, . . . , Aₚ], and that for each such attribute Aₐ, there is a set of one or more different attribute classes Bₐ=[B_{a,1}, B_{a,2}, . . . , B_{a,K}_{ₐ}], where Kₐ is the number of possible attribute classes for attribute Aₐ. Data such as data 300 may then include a plurality of rows rᵢ each corresponding to a particular i:th object proposal OPᵢ. Each object proposal OPᵢ may indicate at least an estimated location Lᵢ of the object, an identifier fᵢ of a feature map layer from which the object proposal originates (e.g. fᵢ→F), one or more confidence scores OC_{i,j} for each of one or more object classes Oⱼ∈0, as well as one or more confidence scores AC_{i,a,k} for each of one or more attributes Aₐ and corresponding attribute classes B_{a,k}. For example, using the data 300 as shown in FIG. 3A as an example, F=[F₁, F₂, F₃]; O=[O₁=“car”, . . . ]; A=[A₁=“color”, . . . ]; and B₁=[B_{1,1}=“red”, B_{1,2}=“blue”, . . . ], with OC_{1,1}=0.79, OC_{2,1}=0.88, OC_{3,1}=0.82, OC_{4,1}=0.77, OC_{5,1}=0.87, OC_{6,1}=0.85, . . . , and AC_{1,1,1}=0.47, AC_{1,1,2}=0.95, AC_{2,1,1}=0.85, AC_{2,1,2}=0.84, AC_{3,1,1}=0.64, AC_{3,1,2}=0.97, AC_{4,1,1}=0.98, AC_{4,1,2}=0.32, AC_{5,1,1}=0.96, AC_{5,1,2}=0.71, AC_{6,1,1}=0.92, AC_{6,1,2}=0.87, . . . .

FIG. 3B schematically illustrates exemplary object locations as proposed by the object proposals of the data 300, as a plurality of bounding boxes 320. The first object proposal OP₁ corresponds to a first bounding box 321, the second object proposal OP₂ corresponds to a second bounding box 322, the third object proposal OP₃ corresponds to a third bounding box 323, the fourth object proposal OP₄ corresponds to a fourth bounding box 324, the fifth object proposal OP₅ corresponds to a fifth bounding box 325, and the sixth object proposal OP₆ corresponds to a sixth bounding box 326, wherein the labels 330 in the upper left corner of each bounding box 320 indicates the number of the corresponding object proposal and row in data 300. In general, it can be seen that the estimated location Lᵢ of each object proposal OPᵢ is here provided as a corresponding bounding box 32i.

In summary of FIGS. 3A and 3B, it is noted that there may be several different bounding boxes (i.e. several different object proposals) for each real object 110 and 112, and that there is a requirement to identify/estimate which of the many proposed bounding boxes (and object proposals) that corresponds to the actual location of the object by post-processing of the data 300.

One conventional technique regularly used for such a task is what is referred to as non-maximum suppression (NMS), which in turn relies on calculating so-called intersection-over-union (IOU) measures in order to identify which bounding box out of a plurality of boxes that correspond to the most likely true location of an object. In brief summary, NMS and IOU work as follows.

When provided with a list of object proposals, such as the tabular data 300, it is first checked which row corresponds to the highest confidence score for a particular object class Oₚ∈O. For the sake of the current example, it can be assumed that the particular object class is that for “car, i.e. O₁. After investigating the data 300, it is found that the highest confidence score O_{i,1} is found on row i=2 (i.e. OC_{2,1}=0.88>OC_{i≠2,1}). Thus, location L₂ corresponding to bounding box 322 is selected as a main bounding box for the object belonging to object class “car”. As a next step, IOU measures are calculated for all other object proposals, which includes finding the overlap between each bounding box 321, 323-326 and the main bounding box 322.

Such an overlap may be defined, for two bounding boxes, as a ratio of an area of the intersection between the two bounding boxes to the combined area of the two boxes. For example, the intersection between two bounding boxes BB₁ and BB₂ may be defined as |BB₁∩BB₂|, and the combined area of the two bounding boxes as |BB₁∪BB₂|, leading to an estimated IOU for the two boxes being IOU_{1,2}=|BB₁∩BB₂₁/|BB₁∪BB₂|. Phrased differently, one may calculate a set of such intersection-over-unions IOU_{i=2,i≠2} for each of the object proposals OP_{i≠2} not corresponding to the main bounding box 322. Of course, the IOU of the main bounding box with itself is by such a definition equal to one, i.e. IOU_{2,2}=1.0.

Once the IOUs between each of the bounding boxes 321, 323-326 and the main bounding box 322 are found, a next step of the NMS operation includes to check whether each of these IOUs exceeds a predefined threshold value (e.g. IOUₜₕ). The corresponding ones of the bounding boxes 321, 323-326 for which the IOUs with the main bounding box exceed IOUₜₕ are discarded from the list and not further considered. The corresponding ones of the bounding boxes 321, 323-326 for which the IOUs with the main bounding do not exceed IOUₜₕ are also discarded from the list, but instead placed on a list of potential candidate bounding boxes (i.e. candidate object proposals) for one or more other objects in the scene.

As an example, the various IOUs may be estimated as IOU_{2,1}=0.54, IOU_{2,3}=0.61, IOU_{2,4}=0.02, IOU_{2,5}=0.07, and IOU_{2,6}=0.11. A threshold value may be assumed to be e.g. IOUₜₕ=0.2, and it may thus be concluded that only the bounding boxes 321 and 323 have overlaps with the main bounding box 322 that exceed the threshold IOUₜₕ. Bounding boxes 321 and 323 are then assumed to be inaccurate localizations of the same object as that of bounding box 322, due to them having sufficiently large overlaps with the location indicated by object proposal OP₂ and bounding box 322. Likewise, the other boxes 324-326 are considered as not being inaccurate localizations of the same object as that of bounding box 322, and are instead added to the list of candidate proposals for one or more other objects. The process is then repeated for this other list. Out of bounding boxes 324-326 and their corresponding object proposals OP₄, OP₅ and OP₆ in the data 300, it is determined that object proposal OP₅ and bounding box 325 correspond to the highest confidence score for the object class “car” (i.e. OC_{5,1}=0.87). New IOUs for the remaining boxes 324 and 326 may then be determined as e.g. IOU_{5,4}=0.43 and IOU_{5,6}=0.69, and by using the same threshold IOUₜₕ=0.2 it may be further determined that both of these measures are above the predefined threshold IOUₜₕ, resulting in both proposals OP₄ and OP, and their bounding boxes being discarded also from this other list and not further considered.

As a result of having performed such a conventional NMS operation on the data 300, object proposal OP₂ is thus selected as the main proposal for one object, and object proposal OP₅ is selected as the main proposal of another object, and the other object proposals are discarded. In order to decide upon what the most likely attribute class is for e.g. the color attribute, the corresponding attribute class confidence scores found in OP₂ and OP₅ are examined, and it is found that for the object 110 of object proposal OP₂, the most likely attribute class for the color attribute is “red” (as AC_{2,1,1}=0.85>AC_{2,1,2}=0.84). Likewise, for the object 112 of object proposal OP₅, the most likely attribute class for the color attribute is also “red” (as AC_{5,1,1}=0.96>AC_{5,12}=0.71). It should be noted that there is not necessarily any concept of “same” or “different” objects in the data 300, and that a purpose of the NMS routine is to establish whether there is likely more than one object in the image 100 of the scene.

The outcome of such conventional NMS-based analysis is thus as schematically illustrated in FIG. 3C, wherein the first object 110 is identified as belonging to object class “car” and with a most likely color attribute class being “red”, while the second object 112 is identified as also belonging to object class “car” with a most likely color attribute class also being “red”, with the locations as provided by object proposals OP₂ and OP₅ and corresponding bounding boxes 322 and 325, respectively, as indicated in FIG. 3C. It can thus be seen that both objects 110 and 112 are correctly located and classified in terms of object classes, but that the color attribute classification of the object 110 is wrong as it is assumed to be red instead of blue. This example thus serves to illustrates how conventional methods for object localization and classification can fail, especially when relying on conventional NMS.

How the present disclosure improves upon contemporary and conventional methods for object localization and classification will now be described in more detail.

As the inventors have realized, conventional methods (such as described above with reference in particular to FIG. 3C) does not appear to take into account that a particular feature map layer may be “good” at providing input useful for estimating/classifying a particular type of attribute, while a same feature map layer may be “less good” at providing input useful for estimating/classifying one or more other types of attributes. For example, higher resolution layers may be better at providing output useful for classification of attributes such as color and texture. Meanwhile, lower resolution layers may include more semantic information and be better at providing output useful for classification of attributes which requires more context, i.e. “contextual attributes”, such as e.g. an attribute indicating whether an object is on a road or not, which would benefit from mix-up of information associated both with e.g. a car and with its surrounding elements (such as the road) as found in the lower-resolution layers. Similarly, lower-resolution layers may be better at providing output more useful for object classification, as it may be hard to detect objects in higher-resolution images with too many details still remaining and with less semantic content.

Using FIGS. 3A and 3B as examples, the best localization of the object 110 was provided based on output from the second feature map layer (e.g. 222-2), as part of object proposal OP₂, while the best classification of the color attribute was provided as part of object proposal OP₃ based on output from the third feature map layer (e.g. 222-3). This is in line with what is stated above, as the third feature map layer 222-3 has higher spatial resolution than the second feature map layer 222-2, and as the second feature map layer provides more semantic information than the third feature map layer. By using conventional NMS, however, the higher-quality prediction/classification of the color attribute provided by the object proposal OP₃ was discarded in favor of that provided by object proposal OP₂, solely due to OP₂ providing a higher confidence score for the classification of the object as belonging to object class “car”. A reason for why object proposal OP₂ provided a higher confidence score for color attribute class “red” may e.g. have resulted from part of the red object/car 112 being within the bounding box 322, or e.g. due to a background around the blue object/car 110 being more reddish, or similar, and e.g. based on features that are all accumulated into the output from the second feature map layer 222-2 due to the lower-resolution input to the second feature map layer 222-2 resulting from the additional convolutions performed higher up in the bottom-up pathway 210 compared to the input provide to e.g. the third feature map layer 222-3.

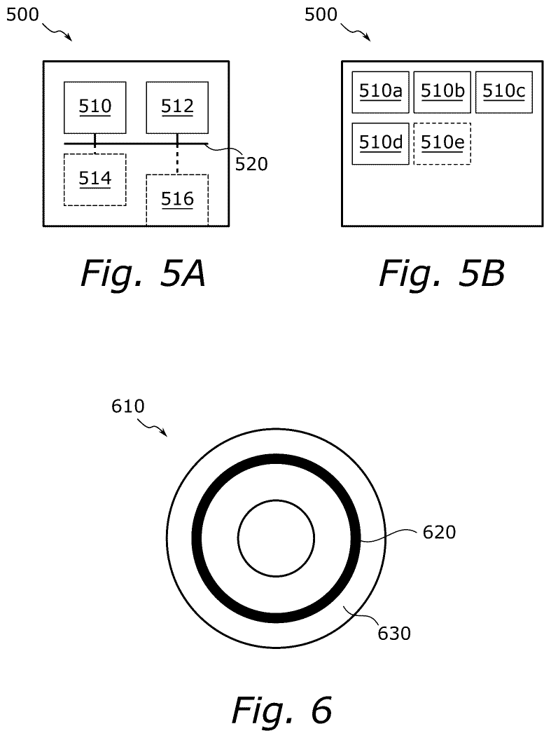

In order to overcome or at least partially alleviate the above issues, the present disclosure proposes an improved post-processing of data such as data 300 in order to better classify attributes, wherein also the origin of (e.g. from which feature map layer) the object proposals are taken into account. With reference also to FIGS. 4, 5A and 5C, such an improved post-processing will now be described in more detail.

FIG. 4 schematically illustrates a flowchart of an exemplary method 400 of object attribute classification in an image, such as in the image 100. As part of an operation S410, the method 400 includes obtaining, from an output of an ANN entity (such as the architecture 200) trained to localize and classify objects in an image using a plurality of feature map layers (such as the layers/stages 316-j), a plurality of object proposals (such as object proposals OP₁ to OP₆) in a same image. Each i:th object proposal OPᵢ includes an object class confidence score (such as OC_{i,p}) for a same first object class (e.g. Oₚ∈O), an estimated object location (e.g. Lᵢ) in the image, and an attribute confidence score for each of one or more different attribute classes (e.g. AC_{i,a,k}, where Aₐ∈A and B_{a,k}∈Bₐ) for a same first attribute (e.g. A_{q}∈A). Moreover, each object proposal OPᵢ is associated with one of the feature map layers/stages, i.e. fᵢ→F.

In an operation S420, the method 400 includes identifying, among the plurality of object proposals OPᵢ and based on their respective indicated object class confidence scores CO_{i,p}, a first set including a main object proposal and one or more other object proposals. For example, using data 300 and FIG. 3B as examples, the first set could include the object proposal OP₂ as the main object proposal, and e.g. object proposals OP₁ and OP₃ as the one or more other object proposals. In other examples, also one or more of object proposals OP₄ to OP₆ could be considered as part of the one or more other object proposals. Phrased differently, the method 400 includes to identify (based on object class confidence scores) a most likely object location, and to also identify one or more other proposals not corresponding to the most likely object location.

In an operation S430, which may be performed before, after or simultaneously with the operation S420, the method 400 includes ranking the feature map layers from a least significant feature map layer to a most significant feature map layer. The ranking may e.g. be the same for all attributes, or the ranking may be different for different attributes. For example, if the attribute is “color”, feature map layers may be ranked according to their spatial resolution, with layers having higher spatial resolution being ranked as more significant than layers having lower resolutions. For example, if considering the first to third feature map layers used in the example of FIGS. 3A and 3B, it may be assumed that for the color attribute, the first feature map layer is the least significant layer, the third feature map layer is the most significant layer, and the second feature map layer is ranked somewhere in between the first and third layers. Ranking may e.g. be performed by assigning a weight coefficient wᵣ to each r:th feature map layer, or similar, as will be described in more detail later herein. When ranking the feature map layers, there may of course, in some situations, be two or more feature map layers with a same ranking.

In an operation S440, the method 400 includes determining an attribute class for the first attribute (i.e. classifying the first attribute as belonging to a particular attribute class for that attribute) based on the one or more attribute class confidence scores AC_{i,a,k} for the (all) members of the first set. This includes taking also the ranking of the feature map layers associated with the one or more other object proposals, as well as object location overlaps (e.g. IOUs) of the main object proposal with the one or more other object proposals, into account as part of this determining.

By not just automatically ranking the feature map layer responsible for providing the most likely object location (e.g. the highest object class confidence score) as the most significant (or only) feature map layer also for classifying the attribute, the present disclosure provides a solution that may improve upon e.g. the problem with contemporary solutions illustrated and described with reference to FIG. 3C. This in particular by ranking the feature map layers depending on how “good” they are at providing useful output for classification of a particular type of attribute.

As described earlier herein, in some examples of the method 400, the locations of the object proposals may be provided as bounding boxes, and to determine object overlaps may include determining and using IOUs. For example, as shown already, this may include calculating IOU_{i′,i≠i}, for each i:th of the one or more other object proposals that are not the i′:th object proposal considered to be the main object proposal.

In some examples of the method 400, taking the ranking and object location overlaps into account may include that an attribute class confidence score indicated by an object proposal that has a larger object overlap with the main object proposal and that is associated with a feature map layer that is ranked as more significant, is made more significant to determining the attribute class of the first attribute than an attribute class confidence score indicated by an object proposal that has a smaller overlap with the main object proposal and that is associated with a feature map layer that is ranked as less significant. For example, if the main object proposal is the i′:th object proposal OPᵢ, and two of the one or more other object proposals are j:th and j′:th object proposals OPⱼ and OP_{j′}, respectively, one may calculate IOU_{i′,j} and IQU_{i′,j′}, and determine that IOU_{i′,j′}>IOU_{i′,j}. If further assuming that the feature map layer fⱼ, is ranked as more significant than the layer fⱼ, it may be concluded that the attribute class confidence score AC_{j′a,k}, should be made more significant when classifying the attribute Aₐ than the confidence score A_{j,a,k}, where k′ and k may or may not be different, and vice versa.

As envisaged herein, one particular example of how to more accurately determining the correct attribute class for the particular attribute Aₐ, as part of e.g. operation S440 of the method 400, can be described as follows.

For each particular attribute class B_{a,k}∈Bₐ of the one or more attribute classes Bₐ for the particular attribute Aₐ, it is iterated over the members of the first set that indicates an attribute class confidence score for the particular attribute class, i.e. over those members of the first set that has an attribute class confidence score AC_{j,a,k}. Using the example of FIGS. 3A and 3B, the particular attribute may e.g. be the color attribute Aₐ₌₁, and the one or more attribute classes may thus be Bₐ₌₁=[B_{1,1}, B_{1,2}], e.g. attribute class “red” and “blue”, respectively. If the first set is defined as including object proposals OP₁ to OP₃, iteration may thus be performed over j=1,2,3, as all of OP₁ to OP₃ indicates an attribute class confidence score AC_{j,a,k}. If considering e.g. the first set to also include object proposals OP₄ to OP₆, iteration may instead be performed over j=1, 2, . . . , 6.

For each iteration, i.e. for each j, it may be determined a term T_{j,a,k} that is equal or proportional to a product of an object location overlap size of the member of the first set with the main proposal, an overall ranking score for the feature map layer associated with the member, and the attribute class confidence score for the particular attribute class k indicated by the member. For example, the term Tⱼ may be written as T_{j,a,k}=Tⱼ⁽¹⁾×Tⱼ⁽²⁾×T_{j,a,k}⁽³⁾, where Tⱼ⁽¹⁾=IOU_{i′,j} is the overlap between object proposal j and the main object proposal i′; where Tⱼ⁽²⁾=R(fⱼ), where R(f) is a function assigning a ranking value to feature map layer f, and where T_{j,a,k}⁽³⁾=AC_{j,a,k} is the attribute class confidence score indicated by the object proposal j for the attribute class k for attribute a.

It may then be determined an overall attribute class score S_{a,k} for the particular attribute a and attribute class k (where Bₖ∈Aₐ), which is equal or proportional to a sum of the terms Tⱼ determined during the above-described iterating over the members of the first set that indicates the attribute class confidence score for the particular attribute class. For example, the overall attribute class score can be determined as S_{a,k}=ΣⱼT_{j,a,k}, or similar, where j=1, 2, 3 or e.g. j=1, 2, . . . , 6 in this or these particular examples.

Finally, classification of the particular attribute can then be performed, as part of e.g. operation S440, by selecting the attribute class B_{a,k}, for which the corresponding overall attribute class score S_{a,k} is the highest, i.e. such that k′=argmaxₖS_{a,k}.

In some examples, iteration over j may be performed only over those object proposals for which the attribute class confidence score AC_{j,a,k} is larger than all other attribute class confidence scores AC_{j,a,k′≠k} for the same attribute a. For example, for the tabulated data 300 of FIG. 3A as an example, this would include iterating only over object proposals OP₂, OP₄, OP₅ and OP₆ when calculating S_{1,1} (i.e. the overall score for the color attribute class “red” for the attribute “color”), and over object proposals OP₁ and OP₃ when calculating S_{1,2} (i.e. the overall score for the color attribute class “blue” for the same attribute “color”).

In some examples, the overall attribute class score S_{a,k} for each particular attribute class k may be defined as being inversely proportional to a number of the members of the first set that are iterated over. For example, if iterating over J members (i.e. object proposals), it may be assumed that S_{a,k}∝1/J.

In some examples, the overall ranking score R(fᵢ) for the particular feature map layer fⱼ associated with the object proposal OP may be defined as a ratio of a ranking score for the feature map layer to a sum of such ranking scores for all of the plurality of feature map layers. For example, it may be determined that a ranking score for a particular m:th feature map layer, R(Fₘ∈F), equals R(Fₘ)=wₘ/Σₗ₌₁^{M}wₗ where wₗ is a ranking score assigned to the l:th feature map layer and M is a total number of feature map layers.

In some examples, the overall attribute class score S_{a,k} may be defined as

$${S}_{a , k} = \frac{{\sum }_{j} ( {IOU}_{{i}^{′} , j} \times R ( {f}_{j} ) \times A {C}_{j , a , k} )}{J} , \qquad ( 1 )$$

$$or e . g .$$

$${S}_{a , k} = \frac{{\sum }_{j} ( {IOU}_{{i}^{′} , j} \times \frac{{w}_{j}}{{\sum }_{{j}^{′}} {w}_{{j}^{′}}} \times A {C}_{j , a , k} )}{J} , \qquad ( 2 )$$

where the iteration over j is either for all object proposals OPⱼ that has a corresponding attribute class confidence score AC_{j,a,k}, or only over the object proposals OPⱼ for which AC_{j,a,k} is larger than all the attribute class confidence scores AC_{j,a,k′≠k} for other attribute classes k′≠k for the particular attribute a. In the above formulations for S_{a,k}, J is the total number of object proposals iterated over. In some examples, the object proposals for which the IOU with the main object proposal are zero may be left out of the iteration, as their zero IOU_{i′,j}-terms will cancel any contribution from these object proposals to the overall attribute class score anyway.

In some examples, the ranking of the plurality of feature map layers may depend on the first attribute a, i.e. such that R(fⱼ)→Rₐ(fⱼ). This may be useful as whether a particular feature map layer is considered to provide “good” or “not as good” output for classifying a particular attribute may depend on the type of the attribute. For example, as mentioned before, higher-resolution feature map layers may be better at providing usable output for classifying of e.g. colors, textures, and similar, but perform worse at providing usable output for classifying more contextual attributes, such as whether an object is located on a road or not, and similar, and vice versa. The ranking of the feature map layers may thus be changed depending on the particular attribute a of interest.

In some examples, finding the main object proposal and the one or more other object proposals of the first set may be performed using NMS, as described earlier herein. For example, the object proposal with the highest object class confidence score OC_{j,p} for the particular object class Oₚ in question may be selected as the main object proposal, and the one or more other object proposals may be defined as the object proposals whose overlap with the main object proposal are large enough (i.e. above the predefined threshold IOUₜₕ) to be discarded from the list. In other examples, the one or more object proposals may be all other object proposals, independent of whether their overlap with the main object proposal is larger than the threshold IOUₜₕ or not.

If reconsidering the example of FIGS. 3A and 3B as a validation of the proposed method, it may be determined that the object proposal OP₂ is the main object proposal, and that IOU_{2,1}=0.54, IOU_{2,3}=0.61, IOU_{2,4}=0.02, IOU_{2,5}=0.07, and IOU_{2,6}=0.11 (with IOU_{2,2}=1.0 by definition). In order to classify the attribute “color” (i.e. A₁) for the bounding box 322 corresponding to the main object proposal OP₂, one can use e.g. equation (1) above. An example ranking of the feature map layers 1, 2 and 3 could be w₁<w₂<w₃, as higher-resolution layers are considered better at outputting useful data for color attribute classification. For example, if assuming that w₃=0.6, w₂=0.3 and w₁=0.1, one obtains that

$${S}_{1 , 1} = \frac{{\sum }_{j ∈ \{ 1 , 2 , 3 \}} ( {IOU}_{2 , j} \times {w}_{j} \times A {C}_{j , 1 , 1} )}{3} = 0.17$$

$$and$$

$${S}_{1 , 2} = \frac{{\sum }_{j ∈ \{ 1 , 2 , 3 \}} ( {IOU}_{2 , j} \times {w}_{j} \times A {C}_{j , 1 , 2} )}{3} = 0.22 .$$

Consequently, as the overall score S_{1,2} for the color attribute class “blue” is larger than the overall score S_{1,1} for the color attribute class “red”, the object 110 would then correctly be classified as being blue instead of red, contrary to the result obtained using conventional NMS only. If instead iterating over all object proposals and not only the ones whose overlap exceed IOUₜₕ, one obtains that

$${S}_{1 , 1} = \frac{{\sum }_{j ∈ \{ 1 , 2 , 3 , 4 , 5 , 6 \}} ( {IOU}_{2 , j} \times {w}_{j} \times A {C}_{j , 1 , 1} )}{6} = 0 \text{.10}$$

$$and$$

$${S}_{1 , 2} = \frac{{\sum }_{j ∈ \{ 1 , 2 , 3 , 4 , 5 , 6 \}} ( {IOU}_{2 , j} \times {w}_{j} \times A {C}_{j , 1 , 2} )}{6} = 0.12 ,$$

i.e. the object 110 would still be correctly classified as “blue” as S_{1,2}>S_{1,1}.
For confirmation, it can also be confirmed that after having selected the object proposal OP₅ as the main object proposal for the object 112, one obtains (after determining that IOU_{5,1}=0.02, IOU_{5,2}=0.07, IOU_{5,3}=0.03, IOU_{5,4}=0.43, and IOU_{5,6}=0.69, and by definition IOU_{5,5}=1.0) that

$${S}_{1 , 1} = \frac{{\sum }_{j ∈ \{ 4 , 5 , 6 \}} ( {IOU}_{5 , j} \times {w}_{j} \times A {C}_{j , 1 , 1} )}{3} = 0 \text{.27}$$

$$and$$

$${S}_{1 , 2} = \frac{{\sum }_{j ∈ \{ 4 , 5 , 6 \}} ( {IOU}_{5 , j} \times {w}_{j} \times A {C}_{j , 1 , 2} )}{3} = 0.01 ,$$

$$or that$$

$${S}_{1 , 1} = \frac{{\sum }_{j ∈ \{ 1 , 2 , 34 , 5 , 6 \}} ( {IOU}_{5 , j} \times {w}_{j} \times A {C}_{j , 1 , 1} )}{6} = 0.14$$

$$and$$

$${S}_{1 , 2} = \frac{{\sum }_{j ∈ \{ 1 , 2 , 3 , 4 , 5 , 6 \}} ( {IOU}_{5 , j} \times {w}_{j} \times A {C}_{j , 1 , 2} )}{6} = 0.11 ,$$

confirming that the object 112 would be correctly classified as red as S_{1,1}>S_{1,2} independently of whether iteration is made over all object proposals or only the object proposals OP₄ and OP₆ whose IOUs exceed IOUₜₕ (including, of course, also OP₅).

As envisaged herein, ranking of the feature map layers can be performed manually based on e.g. user experience, or e.g. in a more automated fashion. For example, it is envisaged that e.g. the feature map layer scores (such as wₗ) can be obtained by using an exhaustive search method to find the optimized weights/scores. For example, if assuming that a score wₗ should lie between 0 and 1, an automated procedure by start by assuming equals scores wₗ=1 to all such scores. Then, for the lower-resolution layers, the procedure may proceed by searching from e.g. 0.9 to 1.0 with an interval of 0.05 to, for a test data set, find a score that corresponds to a best average precision (AP) value or similar. As an example, hyperparameter optimization may be used to search for a particular set of parameters (e.g. feature map layer weights/scores) resulting in an optimal performance. Such optimization may be performed using one or more frameworks available for such purposes, such as e.g. Optuna (as described in more detail in Takuya Akiba et al., Optuna: A Next-generation Hyperparameter Optimization Framework, https://doi.org/10.48550/arXiv.1907.10902).

Herein, it is also envisaged to provide a device, computer program and computer program product for object attribute classification in an image, as will now be described in more detail with reference also to FIGS. 5A, 5B and 6.

FIG. 5A schematically illustrates a device 500 for object attribute classification in an image as discussed earlier herein, i.e. a device configured to perform e.g. the method 400 described with reference to FIG. 4. The device 500 includes at least a processor (or “processing circuitry”) 510 and optionally a memory 512. As used herein, a “processor” or “processing circuitry” may for example be any combination of one or more of a suitable central processing unit (CPU), multiprocessor, microcontroller (μC), digital signal processor (DSP), application-specific integrated circuit (ASIC), field-programmable gate-array (FPGA), graphics processing unit (GPU), etc., capable of executing software instructions stored in the memory 512. The memory 512 may be external to the processor 510, or may be internal to the processor 510. As used herein, a “memory” may be any combination of random-access memory (RAM) and read-only memory (ROM), or any other kind of memory capable of storing the instructions. The memory 512 contains (i.e. stores) instructions that, when executed by the processor 510, cause the device 500 to perform a method as described herein (i.e. the method 400 or any embodiments thereof). The device 500 may further include one or more additional items 514 which may, in some situations, be useful for performing the method. In some example embodiments, the device 500 may for example be a (video) camera, such as a (video) monitoring camera, and the additional item(s) 514 may then include e.g. an image sensor and for example one or more lenses for focusing light from a scene on the image sensor, such that the monitoring camera may capture images of a scene as part of performing the envisaged method. The additional item(s) 514 may also include e.g. various other electronics components needed for capturing the scene, e.g. to properly operate the image sensor and/or lenses as desired, and to gather information pertinent to e.g. a current orientation and/or focal length of the camera and lens(es), which can be used to e.g. establish a current FOV of the camera. Performing the method in a monitoring camera may be useful in that the processing is moved to “the edge”, i.e. closer to where the actual scene is captured compared to if performing the post-processing of the object proposals somewhere else (such as at a more centralized processing server or similar). The device 500 may for example be connected to a network such that the results from performing the method may be transmitted to a user. For this purpose, the device 500 may include a network interface 516, which may be e.g. a wireless network interface (as defined in e.g. any of the IEEE 802.11 or subsequent standards, supporting e.g. Wi-Fi) or a wired network interface (as defined in e.g. any of the IEEE 802.3 or subsequent standards, supporting e.g. Ethernet). The network interface 516 may for example also support any other wireless standard capable of transferring encoded video, such as e.g. Bluetooth or similar. The various components 510, 512, 514 and 516 (if present) may be connected via one or more communication buses 520, such that these components may communicate with each other, and exchange data as required.

The device 500 may for example be a monitoring camera mounted or mountable on a building, e.g. in form of a PTZ-camera or e.g. a fisheye-camera capable of providing a wider perspective of the scene, or any other type of monitoring/surveillance camera. The device 500 may for example be a body camera, action camera, dashcam, or similar, suitable for mounting on persons, animals and/or various vehicles, or similar. The device 500 may for example be a smartphone or tablet which a user can carry and film a scene. In any such examples of the device 500, it is envisaged that the device 500 may include all necessary components (if any) other than those already explained herein, as long as the device 500 is still able to perform the method 400 or any embodiments thereof as envisaged herein. The various components of the device 500 may in some examples be further configured to implement an ANN architecture/entity as described herein, such as e.g. 200 or 201. In other examples, the device 500 may only be configured to receive an output from such an ANN architecture/entity and only perform the post-processing of the plurality of object proposals.

FIG. 5B schematically illustrates one or more embodiments of the device 500 in terms of a number of functional/computing blocks 510a-510d. Each such block 510a-510d is responsible for performing a functionality in accordance with a particular operation of the method 400, as shown in the flowchart of FIG. 4. For example, one such functional block 410a may be configured to obtain the output from the ANN entity (operation S410), another block 510b may be configured to identify the members of the first set (operation S420), another block 510c may be configured to rank (or obtain a ranking of) the feature map layers (operation S430), and another block 510d may be configured to determine the attribute class for the first attribute (operation S440). The device 500 may optionally include e.g. one or more additional function blocks 510e, such as e.g. a block for implementing the ANN architecture or similar.

In general terms, each functional module 510a-e may be implemented in hardware or in software. Preferably, one or more or all functional modules 510a-e may be implemented by the processing circuitry 510, possibly in cooperation with the storage medium/memory 512 and/or the communications interface 516. The processing circuitry 510 may thus be arranged to from the memory 512 fetch instructions as provided by a functional module 510a-e, and to execute these instructions and thereby perform any operations of the method 400 performed by/in the device 500 as disclosed herein.

FIG. 6 schematically illustrates a computer program product 610 including a computer-readable means/storage medium 630. On the computer storage medium 630, a computer program 620 can be stored, which computer program 620 can cause the processor 510 and thereto operatively coupled entities and devices, such as the communication interface 516 and the memory 512, of the device 500 to execute method 400 according to embodiments described herein with reference to e.g. FIGS. 2A, 2B, 3A, 3B, 3D, and 4. The computer program 620 and/or computer program product 610 may thus provide means for performing any operations of the method 400 performed by the device 500 as disclosed herein.

In the example of FIG. 6, the computer program product 610 and computer-readable storage medium 630 are illustrated as an optical disc, such as a CD (compact disc) or a DVD (digital versatile disc) or a Blu-Ray disc. The computer program product 610 and computer-readable storage medium 630 could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 may be stored in any way which is suitable for the computer program product 610 and computer-readable storage medium 630.

In summary of the various embodiments presented herein, the present disclosure provides an improved way post-processing object proposals from an ANN architecture/entity that utilizes feature maps and feature map layers for multiple spatial resolutions. In particular, the present disclosure proposes to not just throw away information in an object proposal just because the particular feature map (layer) used to predict e.g. an object class was not particularly good at that task, as the same feature map (layer) may simultaneously excel at accurately classifying one or more attributes of the object. This because the task of object detection (often based on identifying e.g. contours and shapes instead of things like color, texture, and similar) is often more suitably performed on lower-resolution images, while the task of attribute classification (such as to identify color, texture, and similar) can be more suitable performed on higher-resolution images wherein such information (about e.g. color, texture, etc.) has not yet been lost. By taking into account a ranking of the feature map layers (in terms of their capability of attribute classification), as well as how well each object proposal overlaps (in object location) with a main object proposal, the risk of erroneously classifying a particular attribute as belonging to a wrong attribute class can be reduced. Another advantage is that the envisaged solution does not necessarily require to modify existing ANN-based architectures already used to provide the object proposals, but may instead be implemented solely as a post-processing of such object proposals.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention, from a study of the drawings, the disclosure, and the appended claims.

In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

List of reference numerals

| | |
|---|---|
| 100 | image of scene |
| 110, 112 | objects |
| 200, 201 | ANN architectures |
| 210 | bottom-up pathway |
| 212-j | convolutional stages |
| 214 | plurality of network layers |
| 216-j | feature map layers/stages |
| 220 | top-down pathway |
| 222-j | convolutional stages |
| 230 | head group |
| 232 | object classification module |
| 234 | object localization module |
| 240 | head group |
| 242, 244 | attribute classification modules |
| 300 | data |
| 320-326 | bounding boxes |
| 330 | bounding box index |
| 400 | method |
| S410, 420, 430, 440 | operations |
| 500 | device |
| 510 | processing circuitry |
| 512 | memory |
| 514 | additional circuitry/functionality |
| 516 | interface |
| 510a-e | functional blocks |
| 610 | computer program product |
| 620 | computer program |
| 630 | storage medium |

1. A method of object attribute classification in an image, comprising:
obtaining, from an output of an artificial neural network, ANN, entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers;
identifying, among the plurality of object proposals and based on their respective indicated object class confidence scores, a first set including a main object proposal and one or more other object proposals;
ranking, in terms of ability to extract information useful for classification of the first attribute, the feature map layers from a least significant feature map layer to a most significant feature map layer, and
determining an attribute class for the first attribute based on the one or more attribute class confidence scores of all members of the first set, including taking the ranking of the feature map layers associated with the one or more other object proposals, as well as object location overlaps of the main object proposal with the one or more other object proposals, into account as part of said determining,
wherein determining the attribute class for the first attribute further comprises:
for each particular attribute class of the one or more attribute classes:
iterating over members of the first set indicating an attribute class confidence score for the particular attribute class;
for each iteration, determining a term equal or proportional to a product of an object location overlap size of the member of the first set with the main object proposal, an overall ranking score for the feature map layer associated with the member, and the attribute class confidence score for the particular attribute class indicated by the member, and
determining an overall attribute class score for the particular attribute class as equal or proportional to a sum of the terms determined during the iterating;
and
determining the attribute class for the first attribute as the attribute class having the highest overall attribute class score.

2. The method according to claim 1, wherein the object location of each object proposal is indicated as a bounding box, and wherein the method further comprises using an intersection-over-union, IOU, operation to determine the object location overlaps of the main object proposal with the one or more other object proposals.

3. The method according to claim 1, wherein taking the ranking and object location overlaps into account comprises that an attribute class confidence score indicated by an object proposal having a larger object overlap with the main object proposal and associated with a feature map layer ranked as more significant is made more significant to determining the attribute class of the first attribute than an attribute class confidence score indicated by an object proposal having a smaller object overlap with the main object proposal and associated with a feature map layer ranked as less significant.

4. The method according to claim 1, wherein said iterating is performed only over members of the first set indicating a highest attribute class confidence score for the particular attribute class.

5. The method according to claim 1, wherein the overall attribute class score for each particular attribute class is further defined as inversely proportional to a number of the members of the first set that are iterated over.

6. The method according to claim 1, wherein the overall ranking score for the feature map layer associated with the member is defined as a ratio of a ranking score for the feature map layer to a sum of such ranking scores for all of the plurality of feature map layers.

7. The method according to claim 1, wherein the ranking of the plurality of feature map layers depends on the first attribute.

8. The method according to claim 1, further comprising to identify the main object proposal and the one or more other object proposals using a non-maximum suppression, NMS, operation.

9. The method according to claim 1, wherein the ANN entity comprises a feature pyramid network, FPN, for providing the plurality of feature map layers.

10. The method according to claim 1, wherein the ANN entity comprises a plurality of convolutional layers for providing the different spatial resolutions of the image.

11. A device for object attribute classification in an image, the device comprising processing circuitry configured to cause the device to:
obtain, from an output of an artificial neural network, ANN, entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers;
identify, among the plurality of object proposals and based on their respective indicated object class confidence scores, a first set including a main object proposal and one or more other object proposals;
obtain a ranking, in terms of ability to extract information useful for classification of the first attribute, of the feature map layers from a least significant feature map layer to a most significant feature map layer, and
determine an attribute class for the first attribute based on the one or more attribute class confidence scores of all members of the first set, including taking the ranking of the feature map layers associated with the one or more other object proposals, as well as object location overlaps of the main object proposal with the one or more other object proposals, into account as part of said determining,
wherein to determine the attribute class for the first attribute further comprises to:
for each particular attribute class of the one or more attribute classes:
iterate over members of the first set indicating an attribute class confidence score for the particular attribute class;
for each iteration, determine a term equal or proportional to a product of an object location overlap size of the member of the first set with the main object proposal, an overall ranking score for the feature map layer associated with the member, and the attribute class confidence score for the particular attribute class indicated by the member, and
determine an overall attribute class score for the particular attribute class as equal or proportional to a sum of the terms determined during the iterating;
and
determine the attribute class for the first attribute as the attribute class having the highest overall attribute class score.

12. The device according to claim 11, wherein the processing circuitry is further configured to cause the device to implement the ANN entity.

13. A computer program for object attribute classification in an image, the computer program being configured to, when executed by processing circuitry of a device, cause the device to:
obtain, from an output of an artificial neural network, ANN, entity trained to localize and classify objects in an image using a plurality of feature map layers associated with different spatial resolutions, a plurality of object proposals in a same image, wherein each object proposal indicates at least i) an object class confidence score for a same first object class, ii) an estimated object location in the image, and iii) an attribute class confidence score for each of one or more different attribute classes for a same first attribute, and wherein each object proposal is associated with one of the feature map layers;
identify, among the plurality of object proposals and based on their respective indicated object class confidence scores, a first set including a main object proposal and one or more other object proposals;
obtain a ranking, in terms of ability to extract information useful for classification of the first attribute, of the feature map layers from a least significant feature map layer to a most significant feature map layer, and
determine an attribute class for the first attribute based on the one or more attribute class confidence scores of all members of the first set, including taking the ranking of the feature map layers associated with the one or more other object proposals, as well as object location overlaps of the main object proposal with the one or more other object proposals, into account as part of said determining,
wherein to determine the attribute class for the first attribute further comprises to:
for each particular attribute class of the one or more attribute classes:
iterate over members of the first set indicating an attribute class confidence score for the particular attribute class;
for each iteration, determine a term equal or proportional to a product of an object location overlap size of the member of the first set with the main object proposal, an overall ranking score for the feature map layer associated with the member, and the attribute class confidence score for the particular attribute class indicated by the member, and
determine an overall attribute class score for the particular attribute class as equal or proportional to a sum of the terms determined during the iterating; and
determine the attribute class for the first attribute as the attribute class having the highest overall attribute class score.

14. A computer program product comprising a computer-readable storage medium storing a computer program according to claim 13.
